(19) United States
(12) Patent Application Publication
(10) Pub. No.: US 2019/0049391 A1
(43) Pub. Date: Feb. 14, 2019

(54) METHOD AND APPARATUS FOR MONITORING A MOVING WEB

(71) Applicant: Markus KLEINDORP, Seewald (DE)

(72) Inventor: Markus KLEINDORP, Seewald (DE)

(21) Appl. No.: 15/761,446

(22) PCT Filed: Nov. 3, 2016
(86) PCT No.: PCT/EP2016/076539

§ 371 Date: Mar. 20, 2018

(30) Foreign Application Priority Data
Nov. 11, 2015 (DE) 102015119444.9

(51) Int. Cl. G01N 21/89; G01N 21/88; H04N 5/247; G06T 7/00; H04N 5/225; H04N 5/232

(52) U.S. Cl. CPC G01N 21/8903; G01N 21/8851; H04N 5/247; G06T 7/0004; G06T 2207/30124; H04N 5/23203; G01N 2021/8896; H04N 5/2252; H04N 5/2256

(57) ABSTRACT

A monitoring apparatus (8) for monitoring a moving web (5), especially for defects (F), using analyzed image data of the web (5) comprises at least two camera elements (14, 140) that may be positioned adjacent one another perpendicular to the direction of transport (T) of the web (5). Said device comprises a control and evaluating unit (20, 200) and at least one serial communication link (21, 22) that connects at least one camera element (14, 140) to the control and evaluating unit (20, 200). Each camera element (14) comprises an area scan element (15) for capturing raw data (BI).

The monitoring apparatus (8) comprises at least one camera module (13, 130, 131) that contains at least one camera group (G1, G2) having at least two camera elements (14, 140) and a housing (17). The camera elements (14, 140) of a camera group (G1, G2) are connected to a serial communication link (21, 22). They are designed to forward the raw data (BI) captured by the area scan elements (15) over the serial communication link (21, 22) to the control and evaluating unit (20, 200). The control and evaluating unit (20, 200) is designed for the generation of image data from the raw data (B1) and for analyzing the image data from the camera element (14, 140) of the camera groups (G1, G2).

The invention relates to an apparatus and a method of monitoring a moving web, especially for defects, in accordance with the preambles to the independent claims.

EP 1 654 532 describes an apparatus and a method of detecting defects during the production of tufting products. The apparatus comprises a light source for illuminating the tufting products and an optical detector for detecting the light returning from the tufting product. The optical detector detects intensities of the light reflected from the rear side of the tufting product within the irradiation range and uses the light intensities to detect unevenness in the rear side of the tufting product caused by defects. The light source is a plurality of infrared LEDs. The light emitted by the light source extends at an acute angle to the rear side of the tufting product. The detector comprises a line scan camera and filters to suppress regular brightness signals and for detecting defects from yarn breaks or double thread. The light source and the detector are synchronized to a working cycle of the tufting machine. Multiple detection cycles are run and restrictions in the field of vision occurring from time to time are hidden. Three line scan cameras are provided to monitor the full width of the tufting product.

The subject matter of DE 101 23 870 is an apparatus for automatic monitoring of fabrics on production machines by means of an electro-optical scanning device that is connected to an evaluation unit. The scanning device comprises a plurality of linear sensor elements transverse to the direction of transport that break the fabric down into tracks that partially overlap. Contact image sensor elements are provided as the sensor elements. The advance of the fabric is used as the basis for recording image scans of the fabric.

A sensor system for inspecting moving textile fiber products in which at least three sensors strips are mounted offset or staggered at approximately 90° to the direction of transport of the textile product is known from DE 101 17 698. The sensor strips are manufactured from a plurality of CMOS or CCD elements, with each of these elements comprising at least 20 pixels. The sensor strips are connected to a common evaluation system. They inspect the textile product through a common glass pane.

In a method of automatically monitoring textile reinforcing materials described in EP 2 103 927, an optical image of the reinforcing material extending over the full width of the reinforcing material to be monitored is generated. The image is then analyzed in a computer to detect material properties. The reinforcing material is passed by a static line scanner. The line scanner comprises a light source and a light sensor.

A method of the automatic inspection of textiles and flat products and a switching arrangement wherein the surface of the product is captured in sections by an arrangement of similar color area scan cameras are known from DE 36 39 636 C2. The signals of the three primary colors are digitized and evaluated. The product is lit by a stroboscope if it is in motion.

A method of the type in question and an apparatus for detecting longitudinal defects in a moving web is described in U.S. Pat. No. 5,696,591 A. Image data of adjacent columns of the surface of the web are recorded by multiple cameras, each having a control unit and that are positioned transverse to a direction of transport of the web. The raw data for the web material captured by the cameras is collected, digitized and processed into image data using the control units. Average values are formed for a profile of light intensity over the width of the web and sent to an evaluation unit in which longitudinal defects are detected from the profiles. The evaluation unit is a computer connected by serial communication cables to the cameras. The web is illuminated by a light source that emits IR light, for instance. Each camera is a CCD camera with a CCD area scan, for example with 2048 elements transverse to the direction of transport and 96 elements in the direction of transport. The rate at which the image data is collected is not synchronized with a predefined speed of the web.

The arrangement of a plurality of complete cameras adjacent one another for monitoring a moving web over its entire width is complex and associated with relatively high costs for the cameras.

The subject matter of U.S. Pat. No. 8,058,602 B2 is an elongate industrial camera with a camera arrangement and a separate lens arrangement arranged at a distance therefrom in a housing.

The camera arrangement comprises a circuit board composed of a plurality of sections, wherein each section comprises a plurality of linear sensors, for example linear CMOS sensors, arranged in a row. The industrial camera is designed to record an image of the web in a scale of approximately 1:1. There is no further information regarding the transmission and evaluation of the image data.

The object of the invention is to develop an apparatus and a method of monitoring a moving web, especially for defects that allows cost-effective, reliable monitoring over the entire width.

The problem is solved by the independent claims.

A monitoring apparatus according to the invention for monitoring a moving web, especially for defects, using analyzed image data of the web is provided with at least two camera elements, wherein the camera elements may be positioned perpendicular to the direction of transport of the web. The apparatus comprises a control and evaluating unit and at least one serial communications link that connects the camera elements and the control and evaluating unit. Each camera element comprises an area scan element for capturing raw data.

The image data recorded by an area scan element is referred to below as raw data. In the case of a camera element that supplies black and white images, the raw data comprises the brightness values of the individual elements of the area scan element, also known as pixels.

In the case of a camera element that supplies color images, the raw data comprises the brightness values of the individual elements from which color values can be determined outside of the area scan element.

In an alternative, the raw data of a camera element that supplies color images comprises the color values of the individual elements determined in the area scan element.

The monitoring apparatus comprises at least one camera module. Each camera module comprises at least one camera group with at least two camera elements. Each camera module is provided with a housing. The camera elements of a camera group are connected to a serial communications link. In each camera group the camera elements are designed to forward the raw data recorded by the area scan elements via the serial communication link to the control and evaluating unit. The control and evaluating unit is designed to generate image data for all camera groups from the raw data from the camera elements and to evaluate it.

Camera elements that only record the raw data of an image of the web web that is forwarded to the control and evaluating unit can be produced easily and cost-effectively. They require few additional components in addition to the area scan element. In particular, bringing together camera elements into camera groups and the transmission of the raw data through a common serial communication link minimizes the amount of cabling using a bus-type arrangement.

The raw data that is captured by the area scan elements in the camera elements of a camera group is only transmitted with the aid of correspondingly designed camera elements over a serial communication link and not by means of one link per camera element in each case. This saves mechanical and electronic complexity in the installation and operation of an apparatus in accordance with the invention.

Serial communication links allow powerful communication connections and hence rapid and precise evaluation of the raw data. This makes it possible quickly and reliably to shut down a textile machine producing or processing a web, such as a knitting machine, in the event of defects in the web, for example.

In one embodiment, a camera group contains up to eight camera elements. Eight camera elements are addressed by means of a 3-digit binary code from a corresponding switch, for example. In one example, a switch of this kind is also manually operated.

In one alternative, the camera elements are addressed automatically, wherein each camera element switches on to the next camera element.

In one embodiment, at least one of the camera elements of a camera group has two data links and a multiplexer. In each of these camera elements one data link is designed as a camera data link that is fed to the area scan element of the camera element. The other data link from the camera element is designed as a through data link that is passed through the camera element and that can be connected to a further camera element in the camera group. The two data links from the camera element can be connected to the serial communication link in series using the multiplexer.

All of the camera elements of a camera group, or all camera elements except for the last one, are provided with the two data links and the multiplexer. One of the data links can be connected to the serial communication line by way of the multiplexer. The arrangement of two data links in one camera element makes it possible to connect a plurality of camera elements to one serial communication link without additional lines.

In one embodiment, the multiplexer can be controlled by the control and evaluating unit via the serial communication link.

In one embodiment, a camera module comprises at least two camera groups each with a serial communication link between the camera elements and to the control and evaluating unit. The control and evaluating unit is designed for parallel processing of the raw data from the camera groups.

The image processing speed is increased by parallel processing of the raw data from different camera groups by suitable processors in the control and evaluating unit. It is roughly doubled if, for example, two camera groups are connected.

In one embodiment the control and evaluating unit comprises a processor with at least two cores and a memory module with a common memory area. Advantageously, all cores in the processor use the common memory area.

In one embodiment the camera elements of the camera groups are positioned alternating next to each other in the housing.

An advantage of an alternating arrangement of camera elements from different groups is that the number of camera elements per camera group is of a similar magnitude. This is also true if the alternating arrangement continues in the expansion modules referred to below. This means that the times for the transmission of raw data in the groups are of a similar length.

The housing of a camera module encloses the camera elements arranged adjacent one another. The external contour of the housing is, for instance, substantially cylindrical. In one embodiment the outer contour is round. In other options, the outer contour is rectangular, square or polygonal.

In one embodiment the housing comprises a housing profile. In one example, the housing comprises a housing profile, the outer contour of which has the form of a cylinder open at one side, and at least one removable cover that closes the open side of the housing profile. Removable covers allow good accessibility to elements arranged in the profile, for example the camera elements.

In one embodiment the housing profile and/or the covers of the hosing are designed as sections of extruded profiles. The extruded profiles in one example are produced from aluminum.

In an alternative, the apparatus has a control module with the control and evaluating unit adjacent the camera module(s).

In another alternative, a camera module designed as the master camera module contains the control and evaluating unit.

In one embodiment, the control and evaluating unit is arranged on a cover of the housing.

In one embodiment at least two camera modules are provided, wherein the housings for the camera modules are connected together.

The housings of the two camera modules have sections of the same housing profile. The cross-sections of the housing profiles butt against each other when the camera modules are connected here. In one embodiment a connector is provided that extends in an opening in the profile of the two housings over both camera modules. The connector stabilizes the

connection of the housings.

Further camera modules in addition to the master camera module of the monitoring apparatus are denoted as expansion camera modules.

In one embodiment the monitoring apparatus comprises one master camera module and one expansion camera module in which further camera elements of one or more camera groups are arranged.

In one embodiment the area scan element comprises an area scan sensor and an optical element.

In one example the focus of the optical element may be adjusted.

In one embodiment the area scan sensor is designed as a CMOS area scan sensor. A CMOS area scan sensor makes a high speed of recording possible with low current consumption. In an alternative embodiment the area scan sensor is designed as a CCD area scan sensor.

In one embodiment the area scan elements are each arranged at one camera interval from each other, wherein the camera interval is 0.3 to 2.0 m. The camera interval is preferably 0.5 m to 0.8 m.

The camera interval is selected taking into consideration the distance from the monitoring apparatus to the web and the focal length of the optical element. The shorter the focal length of an optical element, the greater the camera interval that can be specified. A shorter focal length, however, leads to a lower optical quality for a given distance from the web.

The length of a camera module housing is approximately an integer multiple of the camera interval. Preferably the camera modules are provided with two to eight camera elements.

The housing for one camera module comprises one housing section for each camera element.

In one embodiment a circuit board element is provided inside a housing section on which board the camera element is arranged.

In an alternative, the circuit board elements each extend over the entire housing section. The board elements are connected to each other by board-to-board connectors, for example.

In a further alternative, the serial communication link has cables and connectors by means of which the camera elements are connected to one another. The plug connection is designed as an RJ45 plug connection, for instance.

In one embodiment the monitoring apparatus is provided with an illuminating device for the web. The illuminating device comprises at least one lighting element for each camera element having at least two LEDs. The illuminating element is designed in such a way that the LEDs are located on a connection line between the area scan elements.

In an alternative embodiment the LEDs are arranged on a line parallel to the connection line for the area scan elements.

In one embodiment the LEDs are designed as high-performance LEDs that have, for example, an output of at least 1 watt, preferably 2 watts. Given the use of powerful, and hence bright, LEDs, the number of LEDs required for each camera element can be low. This simplifies their arrangement, for example on the connection line between the camera elements.

In one embodiment the LEDs are designed as infrared LEDs and daylight blocking filters are provided in front of the area scan camera. This makes it possible to prevent the influence of shadowing and brightness fluctuations in the visible ambient light.

In one embodiment an optical part, for example a lens, is arranged in front of each LED. In an alternative, the illuminating element comprises at least one LED and an optical part in a common housing.

The methods according to the invention can be performed on the apparatuses according to the invention described. The methods accordingly have the advantages and features of the apparatuses.

In a method according to the invention for monitoring a moving web, especially for defects, the web is transported in a direction of transport. Image data of the web is analyzed. The image data is generated and evaluated with the aid of at least two camera elements, which are positioned adjacent one another perpendicular to the direction of transport of the web, of a control and evaluating unit and of at least one serial communication link that connects at least one camera element to the control and evaluating unit. Raw image data is captured by an area scan element in each camera element.

The raw image data for an image of the web is recorded by at least one camera module that comprises at least one camera group having at least two camera elements. The camera elements of a camera group are connected to a serial communications link. The raw data captured in each camera group by the camera elements is communicated to the control and evaluating unit by way of the serial communication link. Image data is generated from the raw data in the control and evaluating unit and the image data from the camera elements in the camera groups is evaluated.

In one embodiment the raw data captured by an area scan element is fed into the serial communication link by a serializer in each camera element. The serial raw data is parallelized by a deserialize and evaluated in the control and evaluating unit. Serial data transmission ensures reliable transmission of the large volume of raw data. Crosstalk between data lines and problems because of runtime differences are avoided.

In one embodiment the raw data from the area scan elements of the camera elements in the camera group are passed by way of at least one camera element of a camera group. If the camera group comprises two camera elements, for example, each camera element alternately passes its own raw data and the raw data from the second camera element, for instance, to the serial communication link. A camera element is provided with two data links and a multiplexer for forwarding its own and external raw data.

Raw data from the area scan element of the camera element, i.e. its own raw data, is passed over a data link designed as a camera data link to the serial communication link, and

the raw data of an area scan element of at least one further camera element, i.e. external raw data, is passed over a data link designed as a through data link to the serial communication link. The two data links from the camera element are connected to the serial communication link in series using the multiplexer.

In one embodiment the raw data from the camera elements of at least two camera groups is processed in parallel in the control and evaluating unit.

In one embodiment data processed from the raw data by the control and evaluating unit is determined. To this end, the raw data from at least a plurality of lines is totaled and average values determined. In one embodiment the processed data is evaluated by the control and evaluating unit, for defects, for instance, and an alarm message is generated as necessary.

The invention will be explained in more detail on the basis of examples illustrated diagrammatically in the drawing. In the figures:

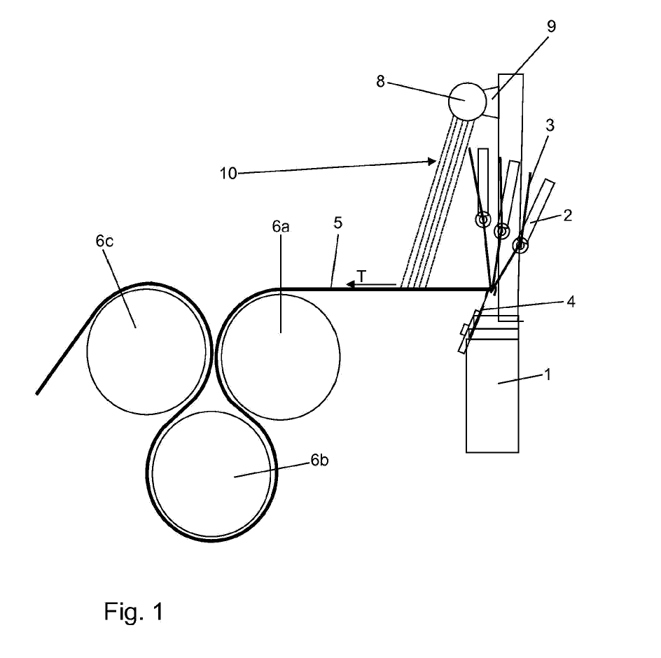

FIG. 1 is a side view of a diagrammatic arrangement of a knitting machine with a monitoring apparatus according to the invention;

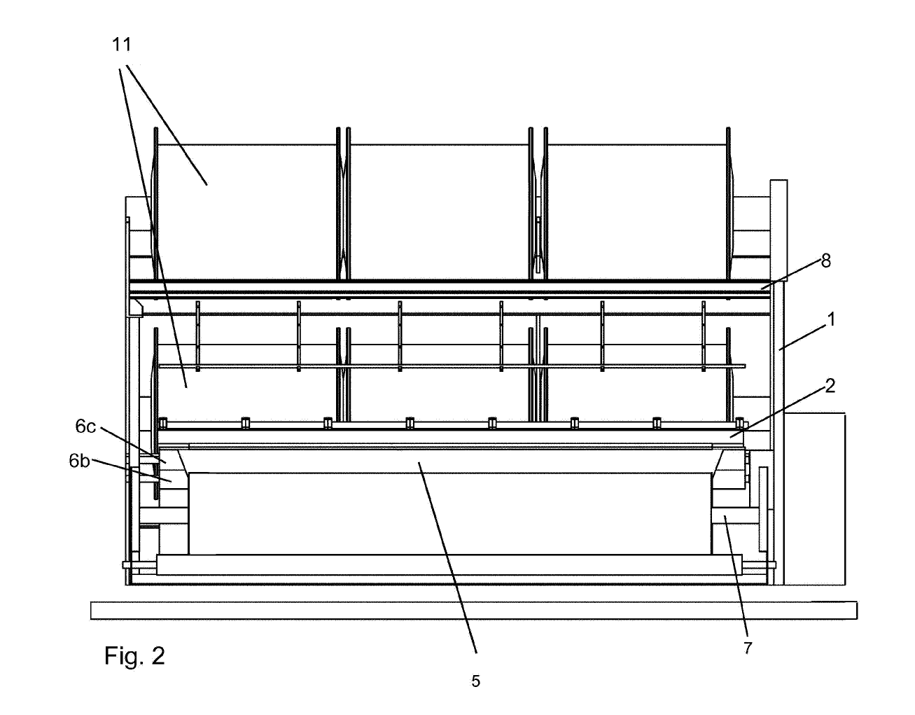

FIG. 2 is a diagrammatic front view of the knitting machine with the monitoring apparatus;

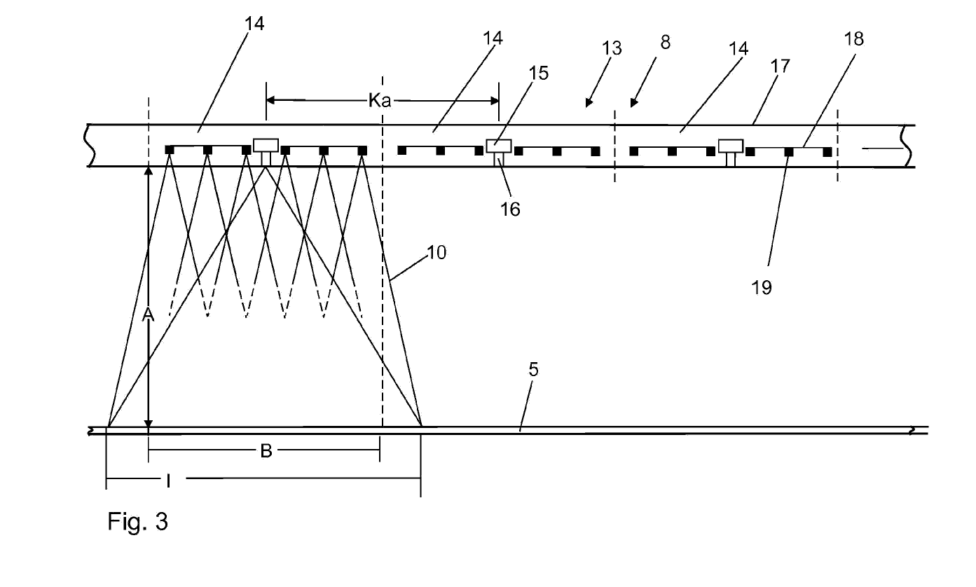

FIG. 3 is a diagrammatic function sketch of the monitoring apparatus of a first example;

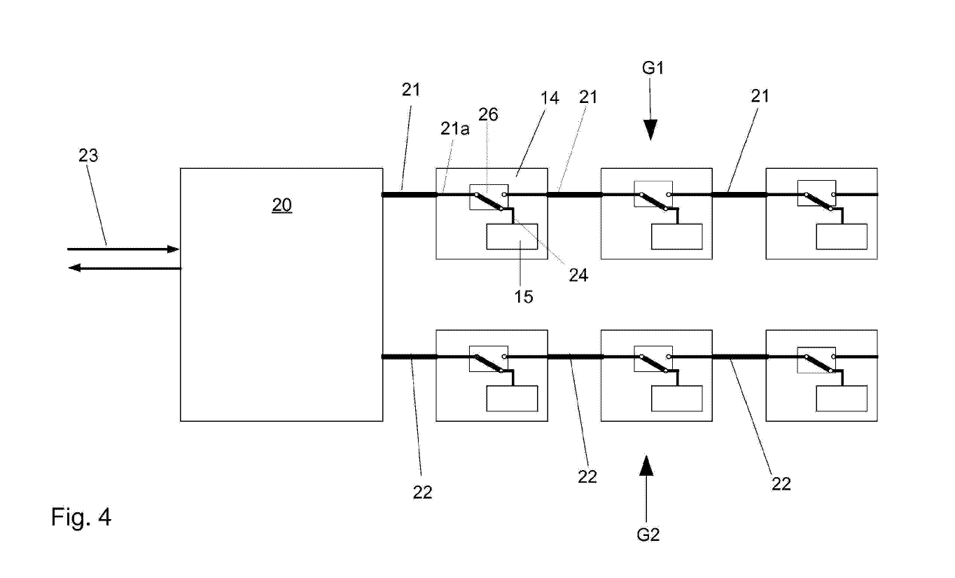

FIG. 4 is a simplified block diagram of camera elements of the monitoring apparatus;

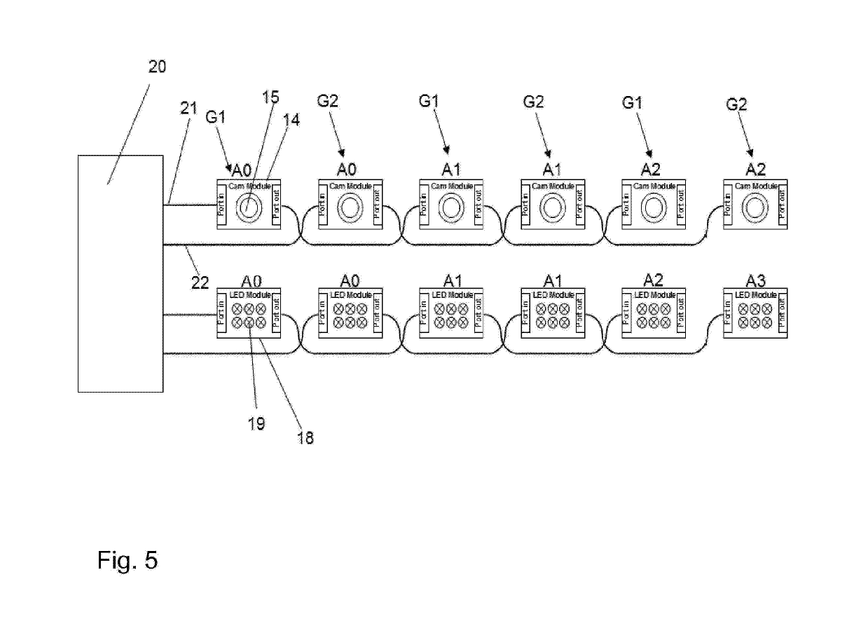

FIG. 5 is a simplified block diagram of the monitoring apparatus;

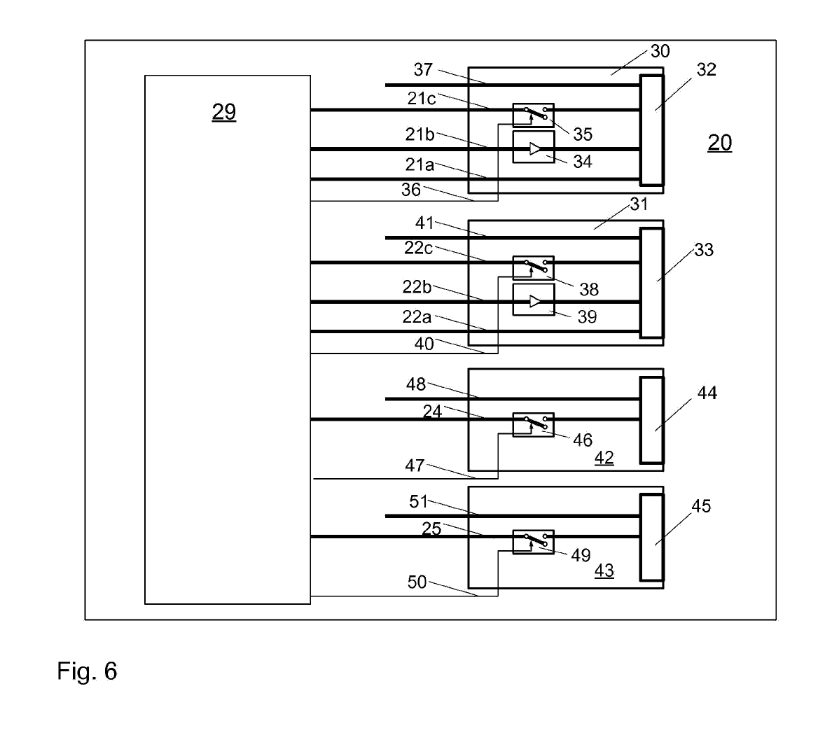

FIG. 6 is a simplified block diagram of a control and evaluating unit of the monitoring apparatus;

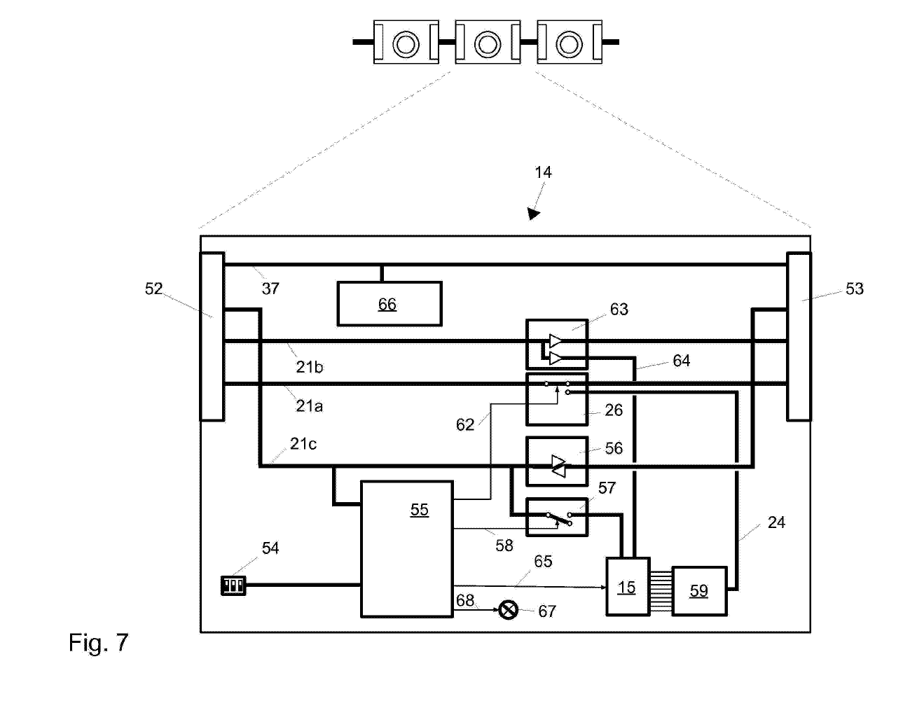

FIG. 7 is a simplified block diagram of a camera element of the monitoring apparatus;

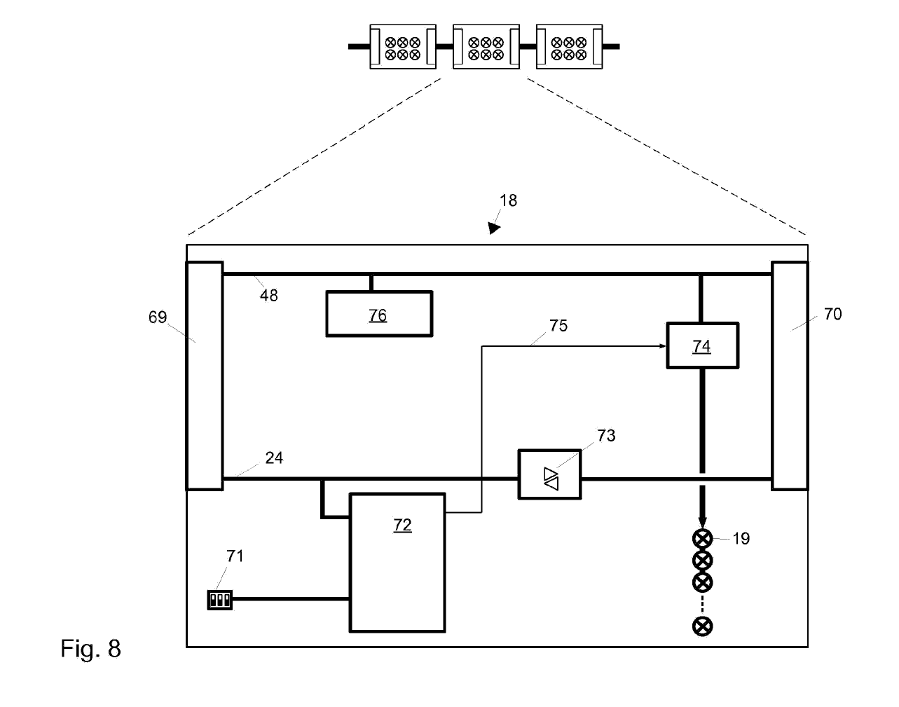

FIG. 8 is a simplified block diagram of an illuminating element of the monitoring apparatus;

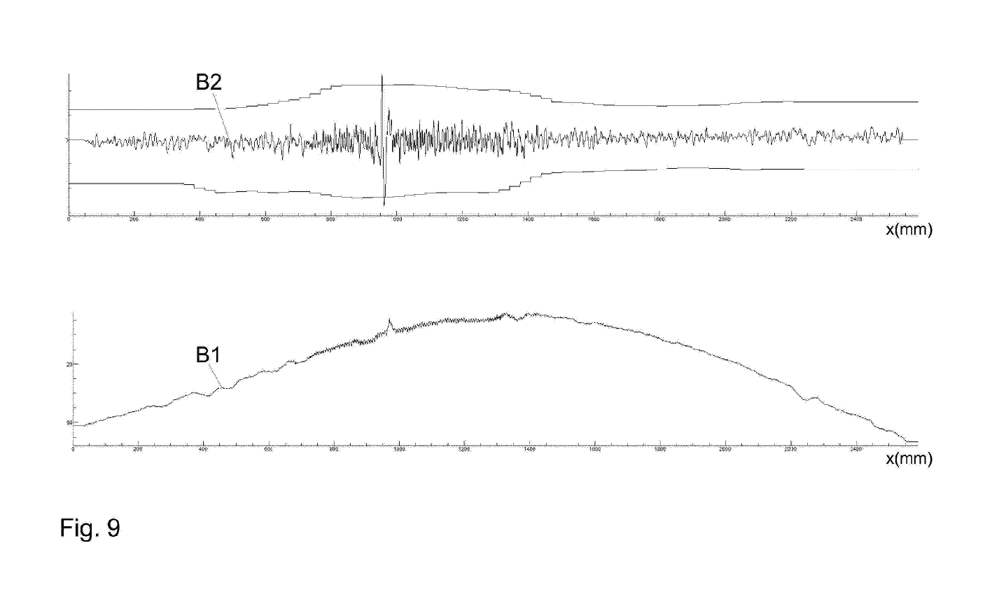

FIG. 9 shows graphs relating to image analysis in the monitoring apparatus;

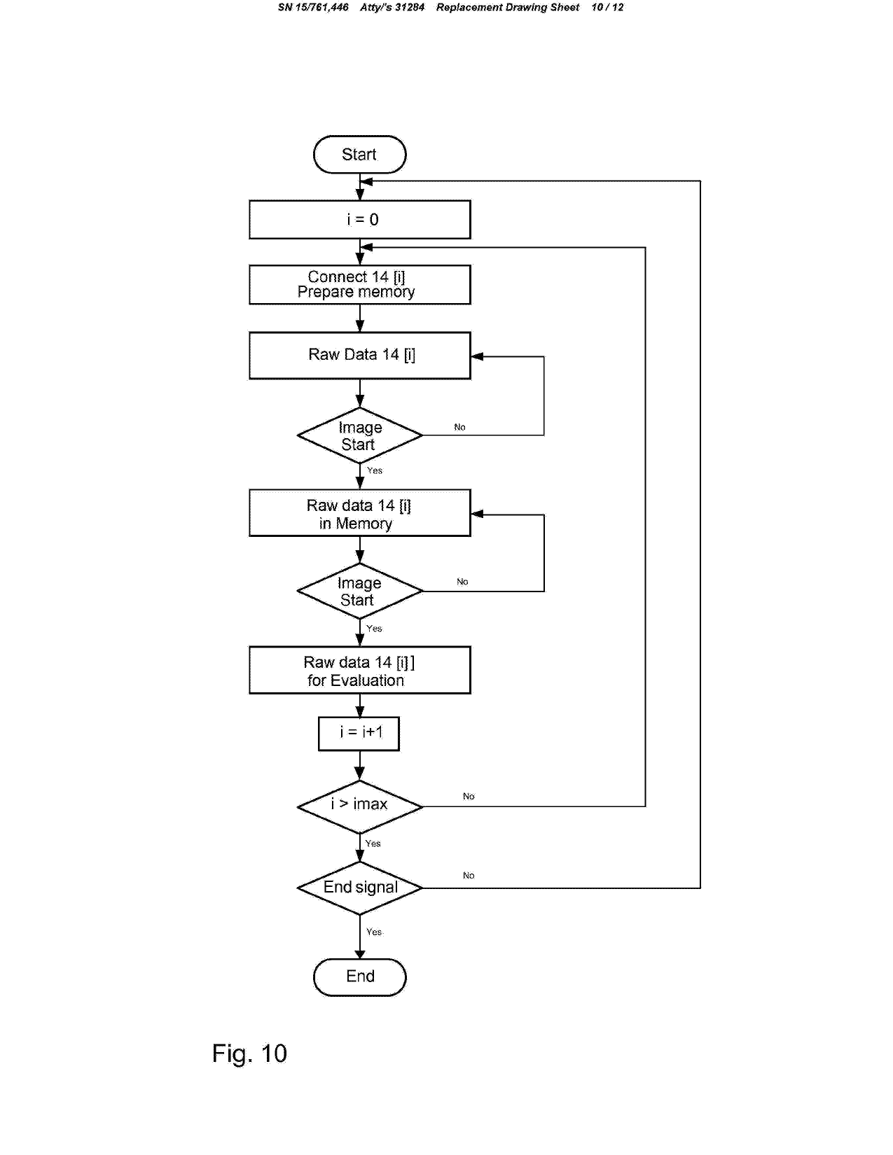

FIG. 10 is a flow chart of the transmission of raw data to the control and evaluating unit;

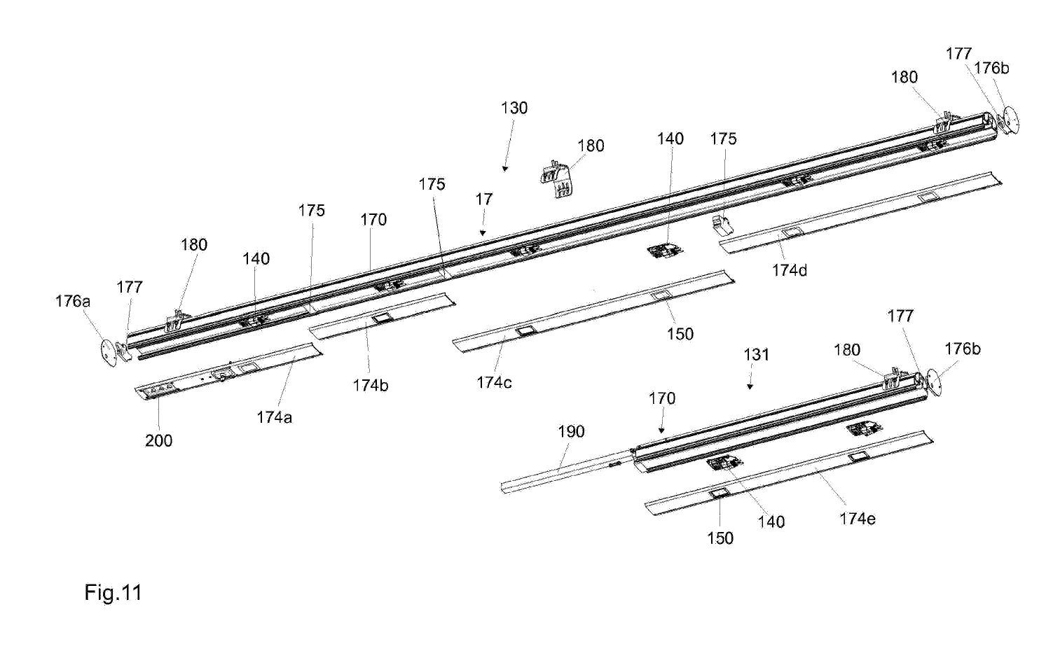

FIG. 11 shows a monitoring apparatus of a second example using a very simplified exploded drawing; and

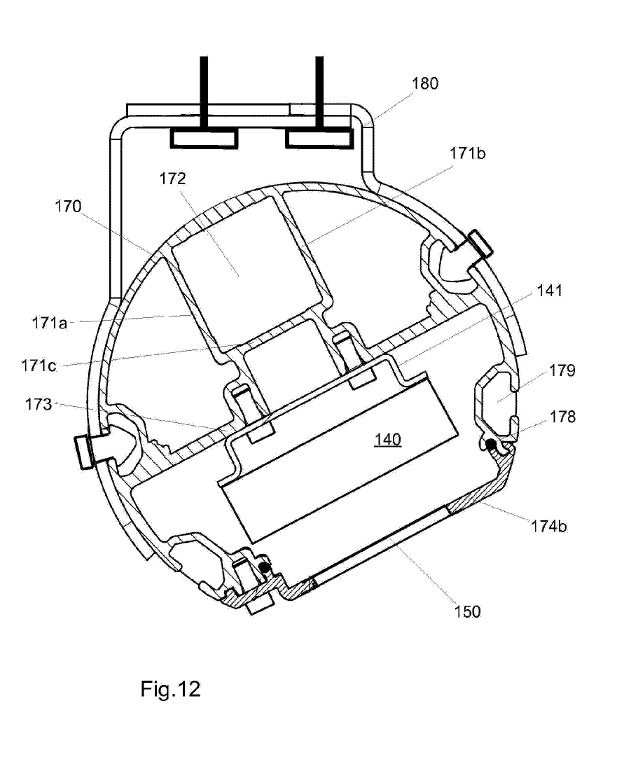

FIG. 12 is a simplified cross-section through the monitoring apparatus of FIG. 11.

### FIRST EXAMPLE

FIG. 1 shows in diagrammatic presentation a knitting machine having a machine frame 1 with knitting tools, for example a warp knitting machine with guide bars 2 for warp yarns 3 and with slider needles 4, of which only one is shown. The web 5 produced on the knitting tools is guided over rollers 6a, 6b, 6c, for instance to a winding device not illustrated.

A monitoring apparatus 8 of the first example according to the invention for monitoring the moving web 5 is arranged above the web 5. The cross-section through the apparatus 8 is indicated in FIG. 1 by a circle. The monitoring apparatus 8 extends transversely to the web. The apparatus 8 is fastened to the machine frame 1 by a fastening device 9. It is arranged after the knitting tools and before the deflection rollers 6a, 6b, 6c in the transport direction T. The apparatus 8 comprises an illuminating device, the light beams 10 from which are aimed at the web 5.

FIG. 2 shows a front view of the knitting machine with the apparatus 8. The machine frame 1 comprises a frame, in which in this example six sectional warp beams 11, the monitoring apparatus 8, guide rails 2 for the needle bars (with slider needles) 4 and the rollers 6b, 6c and a winding-on roller 7 are mounted. The web 5 can be seen in FIG. 2 as it leaves roller 6b and as rolled finished goods on the winding-on roller 7.

The monitoring apparatus 8 extends parallel to the axes of the rollers 6, 7, for example, i.e. transversely to the web 5, on both sides as far as the machine frame 1.

FIG. 3 shows a function sketch of the monitoring apparatus 8. The monitoring apparatus 8 comprises, in this example, a camera module 13 with camera elements 14, of which three may be seen in FIG. 3. The camera elements 14 each comprises an area scan element 15 with an area scan sensor 15a and an optical element 16.

The camera module 13 is provided with a housing 17.

The camera elements 14 are positioned next to each other as a result of the arrangement of the apparatus 8 perpendicular to the direction of transport T of the web 5, i.e. transversely to the web 5. The area scan elements 15 are here arranged in the housing 17 at a camera interval Ka from each other and each in the middle of a camera element 14 extending transversely to the web 5.

The apparatus 8 is arranged at a distance A from the web 5. Distance A is 0.2 m to 2.0 m, particularly from 0.6 to 1.1 m, from the web 5.

The monitored width I, i.e. the width of a section of the web 5 to be monitored, of an area scan element 15 is dependent on distance A and on the camera interval Ka between the area scan elements 15.

The camera interval Ka of the area scan elements 15 is 0.3 m to 2.0 m, preferably 0.5 m to 0.8 m. In this example the area scan elements 15 are arranged next to each other at a camera interval Ka of approximately 0.6 m.

FIG. 3 shows the camera interval Ka between two area scan elements 15, a corresponding width B of a section of the web 5, to which a camera element 14 is assigned and the monitoring width I. The monitoring width I is greater than the width B assigned to a camera element 14. That is to say, the monitoring regions I monitored by two adjacently arranged area scan elements 15 overlap each other somewhat.

The optical element 16 comprises an objective lens that is designed as an S-mount lens, for example. In this example the lens is displaceable in its distance from the area scan sensor 15a and hence the focus of the optical element is adjustable. The focal length is 3 mm to 16 mm, preferably 6 mm to 8 mm.

In an alternative the objective lens comprises at least one lens the lens curvature of which is variable. Lenses with variable lens curvature and hence with variable focal length are liquid lenses.

The focal length of the objective lens is selected as a function of the distance A from the web at a desired camera interval A and a desired monitoring width I.

A housing section of the continuous connector housing 17 is assigned to each camera element 14, wherein the transition from one housing section to the next is shown in FIG. 3 by a dashed line. The width of a housing section of housing 17 of the camera elements 14 corresponds to the width B and is likewise 0.6 m.

The camera elements 14 each comprise, for example a circuit board element with the area scan element 15 not illustrated in the drawing. The optical element 16 is likewise mounted on the circuit board element.

The housing 17 of the camera module 13 comprises light-permeable areas in front of the area scan elements 15 and in front of the LEDs 19.

The housing 17 comprises a section of a housing profile and at least one cover. The housing profile and the cover are produced from aluminum extruded profiles. The housing profile, and hence the housing 17, is provided with a circumferential surface area that is at least partially cylindrical. The diameter of the housing 17 is 7 cm to 18 cm, preferably 10 cm to 15 cm. In this example the diameter is approximately 11 cm, for example 11.2 cm.

In this example the apparatus 8 for monitoring the web is provided with an illuminating device. The illuminating device comprises for each camera element 14 at least one lighting element 18 having a fixture and having, for example, six LEDs 19. The LEDs 19 are arranged on a connection line between the area scan elements 15 or its extension on outer area scan elements 15. Six LEDs 19, three on each side of the area scan element 15, are assigned to the camera elements 14 shown in FIG. 3. The light beams 10 from the six LEDs 19 illuminate the width I to be monitored.

FIG. 4 shows a simplified block diagram of camera elements 14 for the monitoring apparatus 8. The monitoring apparatus 8 of this example comprises the camera module 13 referred to above that comprises two camera groups G1 and G2 each with three camera elements 14. That is to say, the camera module 13 is provided with six camera elements 14 that are divided into two camera groups G1, G2.

The monitoring apparatus 8 is provided with a control and evaluating unit 20 and a serial communication link 21, 22 for each camera group G1, G2. The communication links 21, 22 each connect the camera elements 14 of the camera groups G1, G2 with each other and with the control and evaluating unit 20. The control and evaluating unit 20 is designed for the parallel processing of the raw data recorded by the area scan elements 15.

The serial communication links 21, 22 comprise bus lines for the transmission of data, clock signals and control signals. In this example the data links are designed as LVDS lines. The control links are designed as IC2 bus lines. In a further alternative, the control links are designed as CAN bus lines.

In this example with one camera module 13, said module comprises the control and evaluating unit 20 and the serial communication links 21, 22.

The camera elements 14 of each camera group G1, G2 are designed to pass the raw data recorded by the area scan elements 15 over the associated serial communication link 21, 22 to the control and evaluating unit 20. The control and evaluating unit 20 is designed to generate image data from the raw data and to evaluate it. It can be connected to a machine control system for the knitting machine by a communication line 23.

At least two camera elements 14 of each camera group G1, G2 having three camera elements 14 are provided with two data links and a multiplexer 26. One of the data links is designed as a camera data link 24 that is fed to the area scan element 15 of the camera element 14. The second data link connection is designed as a through data link, a section of a data link 21a of the serial communication link 21 that is passed through the camera element 14. The two data links from the camera element 14 can be connected to the relevant serial communication link 21, 22 in series using the multiplexer 26.

FIG. 5 shows a simplified block diagram of the monitoring apparatus 8. As indicated in FIG. 5, the camera elements 14 of the two groups G1 and G2 are positioned alternating adjacent each other. The serial communication link 21 of the first group G1 connects, seen from left to right, the first, third and fifth camera element 14 with each other and with the control and evaluating unit 20. The serial communication link 22 of the second group G2 accordingly connects the second, fourth and sixth camera element 14 with each other and with the control and evaluating unit 20.

The monitoring apparatus 8 is provided with links 27, 28 to control the illuminating elements 18 of the illuminating device. The link 27 connects the illuminating elements 18 that are assigned to the camera elements 14 of the first camera group G1, to each other and to the control and evaluating unit 20. The same applies correspondingly to link 28.

The links 27, 28 comprise bus lines for control signals.

In this example the links 27, 28 comprise 12C bus lines. In an alternative, the links 27, 28 comprise CAN bus lines.

The control and evaluating unit 20 is designed to switch the LEDs 19 of the control elements 18 on and off individually or in groups by means of control signals.

FIG. 6 shows a simplified block diagram of a control and evaluating unit 20 for monitoring apparatus 8. The control and evaluating unit 20 comprises at least one microprocessor 29 (CPU) and a one control element 30, 31 each with an output 32, 33 for each of the camera groups G1, G2.

The control element 30 for the first camera group G1 comprises sections of the communication link 21 with sections of, for instance, a data link 21a for the transmission of the raw data, a timing link 21b for timing the transmission and a control link 21c for controlling the transmission. The control element 30 comprises a first repeater 34, i.e. a signal amplifier and processor for increasing the range that is connected to the timing link 21b, and a second repeater 35 that may be switched off and that is connected to the control link 21c. The second repeater 35 can be activated by the microprocessor 29 over a control line 36. The control element 30 comprises sections of a power supply link 37.

The power supply link 37 and the control link 21c, the timing link 21b and the data link 21a are connected to output 32. The camera elements 14 of the first camera group G1 can be connected to the control and evaluating unit 20 through this output 32.

The control element 31 for the second camera group G2 is constructed correspondingly. The control element 31 for the second camera group G2 comprises sections of the communication link 22 with sections of, for instance, a data link 22a for the transmission of the raw data, a timing link 22b for timing the transmission and a control link 21c for controlling the transmission. The control element 31 comprises a first repeater 38 that is connected to the timing link 22b, and a second repeater 39 that may be switched off and that is connected to the control link 22c. The second repeater 39 can be activated by the microprocessor 29 over a control line 40. The control element 31 comprises sections of a power supply link 41.

The power supply link 41 and the control link 21c, the timing link 21b and the data link 21a are connected to output 33. The camera elements 14 of the second camera group G2 can be connected to the control and evaluating unit 20 through this output 33.

The control and evaluating unit 20 comprises one supply element 42, 43 with an output 44, 45 each for the illuminating elements 18 of each of the camera groups G1, G2.

The supply element 42 for the first camera group G1 comprises sections of the communication line 24 to the illuminating elements 18. The communication line 24 is designed as a control link. The supply element 42 comprises a repeater 46 that can be switched off and that is connected to the communication line 24. The repeater 46 can be switched off and can be activated by the microprocessor 29 over a control line 47. The supply element 42 comprises sections of a power supply link 48.

The power supply link 48 and the communication line 24 are connected to the output 44. The illuminating elements 18 of the first camera group G1 can be connected to the control and evaluating unit 20 through this output 44.

The supply element 43 for the second camera group G2 is constructed correspondingly. The supply element 43 comprises sections of the communication line 25 to the illuminating elements 18. The communication line 25 is designed as a control link. The supply element 43 comprises a repeater 49 that can be switched off and that is connected to the communication line 25. The repeater 49 can be switched off and can be activated by the microprocessor 29 over a line 50. The supply element 43 comprises sections of a power supply link 51.

The power supply link 51 and the communication line 25 are connected to the output 45. The illuminating elements 18 of the second camera group G2 can be connected to the control and evaluating unit 20 through this output 45.

FIG. 7 shows a simplified block diagram of a camera element 14 of the monitoring apparatus 8. The camera element 14 shown in FIG. 7 is, for example the first camera element 14 of the first camera group G1 having the area scan element 15 that is designed as a CMOS sensor.

The camera element 14 is provided with an input 52 and with an output 53 for the following camera element 14, for example the second camera element 14 of the first camera group G1. It comprises sections of the power supply link 37 and the serial communication link 21, that is to say the data link 21a, the timing link 21b and the control link 21c that are each connected to the input 52 and the output 53.

The camera element 14 comprises an addressing switch 54, an IO expander 55, a repeater 56 and an activatable repeater 57. The IO expander 55 is connected to the control link 21c and linked to the addressing switch 54. The control link 21c can be connected to the area scan element 15 by the activatable repeater 57. The activatable repeater 57 can be switched by the IO expander 55 via a line 58. The repeater 56 is connected into the control link 21c.

The section of the data link 21a forms the through data link of the camera element 14.

The camera element 14 comprises a serializer 59, to which the outputs of the area scan element 15 are connected. It comprises the multiplexer 26 referred to above which is connected into the data link 21a. The serializer 59 is connected to the multiplexer 26 through the camera data link 24. The multiplexer 26 can be switched by the IO expander 55 via a line 62 or multiple lines.

The camera element 14 comprises a repeater 63 that is connected into the timing link 21b. The area scan element 15 is connected by a line 64 to the repeater 63 and hence to the timing link 21b. The area scan element 15 can be controlled by the IO expander 55 via a line 65 or multiple lines.

The camera element 14 comprises a voltage regulating unit 66 that is connected into the power supply link 37.

The camera element 14 comprises one or more position lighting elements, in this example red LEDs 67 that may be switched on by the IO expander 55 over a line 68. They indicate the position of the product defect detected.

FIG. 8 shows a simplified block diagram of an illuminating element 18 of the monitoring apparatus.

The illuminating element 18 is assigned to the camera element 14 described above. It is provided with an input 69 and an output 70. It comprises sections of the power supply link 48 and the communication line 24 that are each connected with the input 69 and the output 70.

The illuminating element 18 comprises an addressing switch 6671, an IO expander 67 and a repeater 73. The IO expander 72 is connected to the communication link 24 and linked to the addressing switch 71. The repeater 73 is connected into the control link 24.

The illuminating element 18 comprises a driver 74 for the LEDs 19 that is connected between the power supply link 48 and the LEDs 19. The driver 74 can be controlled by the IO expander 72 via a line 75.

The illuminating element 18 comprises a voltage regulating unit 76 that is connected into the power supply link 48.

In an alternative the position elements described above can be controlled by the IO expander 72 of the illuminating element 16. In this case they are connected to the IO expander 72 and not to the IO expander 55.

FIG. 9 shows graphs relating to image analysis by the control and evaluating unit 20 in the monitoring apparatus.

Raw data B1 of all image sections are recorded over a width X (in millimeters) of a narrow illuminated strip of the web 5. Data B1 (image data) of a brightness profile over the width X of the web 5 is derived from the raw data B1 of each image section. To this end, the raw data BI of the image section is collated into blocks and average values are determined. A block comprises a few pixels transverse to the direction of transport and a few pixels in the direction of transport, three each, for instance. Its average value is a value for the data B1 of the brightness profile of the lower graph in FIG. 9.

In the course of evaluation by the control and evaluating unit 20, the data B1 of the brightness profile is normalized and filtered into data B2 (evaluated image data). Normalization compensates for intensity losses of the brightness profile in the edge region of the web caused by lens curvature of the optical element 16.

The normalized and filtered data B2 of the brightness profile can be seen in the upper graph in FIG. 9. Both the graph with the data B1 and the graph with the data B2 show the impact of a brighter, defect area between 950 and 1000 mm.

In an alternative an apparatus 8 according to the invention for monitoring the moving web 5 is located beneath the web 5.

In an alternative the monitoring apparatus comprises at least two camera modules. The housings 17 of the camera modules are here connected with one another.

In an alternative, a monitoring apparatus comprises the camera module 13 described above that comprises the control and evaluating unit 20 and a further camera module having two camera groups each having two camera elements. The camera module 13 is also identified as the master camera module. Further camera modules are identified as expansion modules.

The expansion module(s) comprise the same number of camera groups as the master camera module.

In operation, the moving web 5, which is being transported in the direction of transport T, is monitored by the monitoring apparatus 8, especially for defects. Image data of the web 5 is analyzed to this end. The image data in this example is generated and analyzed with the aid of a plurality of camera elements 14 positioned next to each other perpendicular to the direction of transport of the web 5, the control and evaluating unit 20 and the communication links 25 that connect the camera elements 14 and the control and evaluating unit 20. The raw data for the image data is captured by the area scan elements 15 of the various camera elements 14.

The raw data is captured by the camera module 13 that comprises the camera groups G1, G2 and the housing 17. The raw data captured by the area scan elements 15 is passed by the camera elements 14 of each camera group G1, G2, which are connected to the associated serial communication link 21, 22, through the serial communication link 21, 22 to the control and evaluating unit 20. Image data is generated from the raw data by the control and evaluating unit 20. The image data from the camera elements 14 of the camera groups G1, G2 is evaluated by the control and evaluating unit 20.

The raw data from the area scan elements 15 of the camera elements 14 of one of the camera groups G1, G2 is passed via the camera elements 14 of the camera group G1 or G2 to the corresponding serial communication link 21, 22.

As mentioned, the camera elements 14 are provided, to this end, with two data links, specifically the data link configured as a camera data link 24 and the data link configured as a through data link, i.e. to the section of the data link 21a, and with the multiplexer 26.

The raw data from the area scan element 15 of the camera element 14 under consideration is passed via the camera data link 24 and the raw data from the area scan elements 15 of further camera elements 14 in camera group G1, G2 is passed via the through data link, i.e. to the section of the data link 21a, to the serial communication link 21, 22. The two data links for the camera element 14 are connected in sequence to the appropriate serial communication link 21, 22 through the multiplexer 26.

The raw data from the camera elements 14 of the camera groups G1, G2 is processed in parallel in the control and evaluating unit 20.

FIG. 10 shows a schematic flow chart for the transmission of the raw data from the camera elements 14 of a camera group G1, G2 to the control and evaluating unit 20 by the control and evaluating unit 20.

Here initially, for each camera group G1, G2 the first camera element 14[0], to which the index i=0 is assigned within its group, is connected to the control and evaluating unit 20. Once the link is made, a memory area is made available in the control and evaluating unit 20. The raw data from the camera element 14[0] is transmitted and written to the memory as soon as an image start is detected. The next time an image start is detected, the raw data from the camera element 14[0] is forwarded from the memory for analysis. The index i is incremented by 1 and the corresponding next indexed camera element 14[i] of camera group G1, G2 is connected to the control and evaluating unit 20. The procedure is repeated for the further camera elements 14[i] until the raw data of the last camera element (the third, in the case of three camera elements 14 per camera group G1, G2) is read and forwarded. The index is then reset to 0 and the first camera element 14[i0] of camera group G1, G2 is thereby connected again to the control and evaluating unit 20.

As long as the web is being monitored, for example as long as the knitting machine (see FIG. 1) producing the web is in operation, data transmission is repeated. It ends after the end signal.

### SECOND EXAMPLE

The second example corresponds to the first example apart from the features described below. The monitoring apparatus of the second example is illustrated in FIGS. 11 and 12. It comprises two camera modules, one master camera module 130 and one expansion camera module 131.

The master camera module 130 comprises a control and evaluating unit 200 and six camera elements 140, three each to a camera group G1, G2. The first, third and fifth camera element belongs to the first camera group G1 and the other camera elements 140 belong to the second camera group G2. The expansion camera module 131 comprises two camera elements 140, wherein the first camera element belongs to the first camera group and the second camera element 140 belongs to the second camera group.

FIG. 12 shows a cross-section through, for example, the housing 17 of the master camera module 130 in the region of a camera element 140. The housing 17 comprises a housing profile 170 extending over the length of the master camera modules 130, the outer contour of which profile takes the form of a cylinder open on one side. In its half opposite the open side, the housing profile 170 comprises partition walls 171a, 171b and 171c that form an approximately square opening 172 extending over the length of the master camera module 130. The housing profile 170 is provided with a center wall 173 extending over the length of the master camera module 130. The camera elements 140 are mounted on the center wall 173. In this example the center wall 173 is interrupted. The cavity thereby created is used as a cable duct.

The housing 17 of the master camera module 130 comprises a plurality of covers 174a, 174b, 174c, 174d closing the open side. The control and evaluating unit 200 is mounted on the cover 174 on the left in the figure. The control and evaluating unit 20 is accessible by simply releasing the cover 174.

FIG. 11 shows two end covers 176a, 176b for the two ends of housing profile 170 for the housing 17 of the master camera module 130, for example for an application without expansion camera modules.

Seals 175 are provided at the points at which the covers 174a to 174d butt against one another. Further seals 177 are provided between the housing profile 170 and the end covers 176a, 176b. The seals 175, 177 are disc-shaped. Sealing strips 178 are provided extending along between the housing profile 170 and the covers 174 to 174d.

The housing profile 170 is provided with a plurality of longitudinal slots 179. A plurality of brackets 180 for the monitoring apparatus 8 are each secured in two of the longitudinal slots 179 at a distance from each other in the longitudinal direction. The longitudinal slots 179 and the slotted holes that cannot be seen in the brackets 180 are arranged in such a manner that the monitoring apparatus 8 can be positioned in different inclinations to the web 5.

The expansion camera module 131 is constructed the same as the master camera module 130 in the region of the camera elements 140. Its housing 17 comprises a housing profile 170 and a cover 174e. The housings 17 of the two camera modules 130 and 131, specifically their housing profiles 170, are connected with one another. The ends of the housing profiles 170, against which the camera modules 130, 131 butt, are open, i.e. have no end cover 176. A longitudinally extending profile 190, made of steel for instance, is arranged in the openings 172 of the housing profiles 170 of the two camera modules 130, 131. The profile 190 stabilizes the connection of the two camera modules 130, 131. Its length corresponds to at least one camera interval Ka. In this example the length of the profile 190 is approximately twice the camera interval Ka.

In this example the monitoring apparatus is executed without illuminating device. The light-permeable regions of the housing 17 are formed by transparent windows 150 in the covers 174. The area scan elements 15 record the images of the web through the windows 150.

In an alternative monitoring unit with illumination, windows extending over the entire length are provided in the covers 174, for example. In an alternative the monitoring apparatus comprises a larger expansion module that comprises four camera elements, of which the first and third belong to the first camera group and the second and fourth belong to the second camera group.

In further alternatives the monitoring apparatus comprises a plurality of expansion modules of the same size or of different sizes.

List of reference numbers

| | |
|---|---|
| 1 | Machine frame |
| 2 | Guide rail |
| 3 | Warp yarn |
| 4 | Needle bars (with slider |
| | needles) |
| 5 | Web |
| 6 | Roller |
| 7 | Roller |
| 8 | Apparatus |
| 9 | Mounting device |
| 10 | Light beam |
| 11 | Warp beam |
| 13 | Camera module (master camera |
| | module) |
| 14 | Camera element |
| 15 | Area scan element |
| 15a | Area scan sensor |
| 16 | Optical element |
| 17 | Housing |
| 18 | Illuminating element |
| 19 | LED |
| 20 | Control and evaluating unit |
| 21 | Communication link |
| 22 | Communication link |
| 24 | Camera data link |
| 26 | Multiplexer |
| 27 | Link |
| 28 | Link |
| 29 | Microprocessor |
| 30 | Control element |
| 31 | Control element |
| 32 | Output |
| 33 | Output |
| 34 | First repeater |
| 35 | Second repeater |
| 36 | Control line |
| 37 | Power supply link |
| 38 | First repeater |
| 39 | Second disconnectible |
| | repeater |
| 40 | Control line |
| 41 | Power supply link |
| 42 | Supply element |
| 43 | Supply element |
| 44 | Output |
| 45 | Output |
| 46 | Disconnectible repeater |
| 47 | Line |
| 48 | Power supply link |
| 49 | Disconnectible repeater |
| 50 | Line |
| 51 | Power supply link |
| 52 | Input |
| 53 | Output |
| 54 | Addressing switch |
| 55 | IO expander |
| 56 | Repeater |
| 57 | Activatable repeater |
| 58 | Line |
| 59 | Serializer |
| 62 | Line |
| 63 | Repeater |
| 64 | Line |
| 65 | Line |
| 66 | Voltage regulation unit |
| 67 | Red LED |
| 68 | Line |
| 69 | Input |
| 70 | Output |
| 71 | Addressing switch |
| 72 | IO expander |
| 73 | Repeater |
| 74 | Driver |
| 75 | Line |
| 76 | Voltage regulation unit |
| 130 | Master camera module |
| 131 | Expansion camera module 140 |
| | Camera element 150 Window |
| 170 | Housing profile |
| 171a, b, c | Partitions |
| 172 | Opening |
| 173 | Center wall |
| 174a-e | Cover |
| 175 | Seal |
| 176a, b | End cover |
| 177 | Seal |
| 178 | Seal strip |
| 179 | Slot |
| 180 | Bracket |
| T | Direction of transport |
| A | Distance |
| B | Width of camera module |
| D | Housing diameter |
| I | Width of region captured |
| X | Width of web |
| G1 | Camera group |
| G2 | Camera group |
| BI | Raw data for an image |
| B1 | Processed data |
| B2 | Normalized data |
| F1 | Error signal |
| F1 | Noise signal |

1. In an apparatus for monitoring a web moving in a transport direction using analyzed image data of the web, the apparatus having
at least two camera elements adjacent one another perpendicular to the direction of transport of the web,
a control and evaluating unit, and
at least one serial communication link that connects at least one camera element and the control and evaluating unit, each camera element having an area scan element for recording raw data, the improvement comprising:
at least one camera module, that comprises at least one camera group having at least two camera elements and a housing, the camera elements of each camera group being connected to a serial communication link,
the camera elements in each camera group transmitting the raw data captured by the area scan elements over the serial communication link to the control and evaluating unit; and
the control and evaluating unit generating image data from the raw data and analyzing the image data from the camera elements of the camera groups.

2. The monitoring apparatus according to claim 1, wherein
at least one of the camera elements of a camera group comprises two data links and a multiplexer, one of the data links being a camera data link extending to the area scan element of the camera element, the other of the data links being a through data link passing through the camera element and connectable to a data link of a further camera element of the camera group the two data links of the camera element are connectable via the multiplexer to the serial communication link.

3. The monitoring apparatus (8) according to claim 1, wherein
each camera module (13, 130, 131) comprises at least two of the camera groups (G1, G2) and
the control and evaluating unit effects parallel processing of the raw data from the camera groups (G1, G2).

4. The monitoring apparatus according to claim 3, wherein the camera elements of the camera groups are positioned alternating adjacent each other in the housing.

5. The monitoring apparatus in accordance with claim 1, wherein one of the camera modules is a master camera module and contains the control and evaluating unit.

6. The monitoring apparatus in accordance with claim 1, wherein at least two camera modules are provided whose housings are connected together.

7. The monitoring apparatus according to claim 1, wherein the area scan element comprises an area scan sensor and an optical element.

8. The monitoring apparatus according to claim 1, wherein adjacent array elements are spaced from one another at a camera interval of 0.3 m to 2.0 m.

9. The monitoring apparatus in accordance with claim 1, further comprising:
an illuminating device that comprises at least one illuminating element for each camera element having LEDs arranged on a connection line of the area scan elements.

10. In a method of monitoring a moving web wherein
the web is transported in a direction of transport,
image data of the web is analyzed,
the image data is generated and analyzed with the aid of at least two camera elements positioned adjacent one another and perpendicular to the direction of transport of the web, of a control and evaluating unit and of at least one serial communication link that connects at least one camera element and the control and evaluating unit, and
raw data for the image data is captured by an area scan element of each camera element, the improvement comprising the steps of:
capturing the raw data by at least one camera module having at least one camera group having at least two camera elements and a housing, the camera elements of a camera group being connected to a serial communication link,
transmitting in each camera group by the respective camera elements the raw data captured by the area scan elements over the serial communication link to the control and evaluating unit, and
generating image data from the raw data by the control and evaluating unit and analyzing the image data from the camera elements of the camera groups.

11. The method in accordance with claim 10, further comprising the steps of:
passing raw data from the area scan elements of at least two camera elements of the camera group through at least one camera element of a camera group provided with two data links and with one multiplexer over two data links to the serial communication link
passing raw data from the area scan element of the camera element through a data link designed as a camera data link and passing raw data from the area scan element of at least one further camera element through a data link designed as a through data link to the serial communication link by the two data links of the camera element connected in sequence to the serial communication link through the multiplexer.

12. The method in accordance with claim 11, further comprising the step of:
processing the raw data from the camera elements of at least two camera groups in parallel in the control and evaluating unit.
